(19) United States
(12) Patent Application Publication
(10) Pub. No.: US 2014/0263187 A1
(43) Pub. Date: Sep. 18, 2014

(54) GAS-INSULATED DEVICE FOR ELECTRICAL POWER AND OPERATION METHOD THEREOF

(71) Applicant: Kabushiki Kaisha Toshiba, Tokyo (JP)

(72) Inventors: Akira Yamada, Tokyo (JP); Hisao Oomura, Kanagawa-ken (JP); Hirofumi Okabe, Kanagawa-ken (JP); Kei Kawasaki, Kanagawa-ken (JP); Amane Majima, Kanagawa-ken (JP)

(73) Assignee: Kabushiki Kaisha Toshiba, Tokyo (JP)

(21) Appl. No.: 14/177,334

(22) Filed: Feb. 11, 2014

(30) Foreign Application Priority Data
Mar. 15, 2013 (JP) 2013-054241

(51) Int. Cl. H01H 33/76

(52) U.S. Cl. CPC H01H 33/765
USPC 218/63

(57) ABSTRACT

A gas-insulated device for electrical power is disclosed that includes: a fixed contact unit and a movable contact unit which are disposed to face with each other in an airtight container filled with a carbon dioxide gas or a gas mixture including a carbon dioxide gas, serving as an arc extinguishing gas. The fixed contact unit includes a fixed arc contact, a fixed conduction contact disposed outside the fixed arc contact, and a conductive supporting member for electrically connecting between the fixed arc contact and the fixed conduction contact and supporting these contacts.

### CROSS REFERENCE TO RELATED APPLICATION

This application is based on and claims the benefit of priority to Japanese Application No. P2013-054241, filed on Mar. 15, 2013, the entire contents of which are incorporated herein by reference.

### TECHNICAL FIELD

The present disclosure relates to a gas-insulated device for electrical power and an operation method thereof.

### BACKGROUND

Electric power transmission/distribution and transformation systems have employed various devices such as a gas-insulated switchgear, a gas circuit breaker, a gas disconnector, a gas-insulated transformer, a gas-insulated power line and so on using a sulfur hexafluoride (SF₆) as an insulating medium. A SF₆ gas acts as a cooling medium to cool heat generated in electrical conduction by a convection current as well as a high voltage insulating medium for these device, or an arc extinguishing medium to extinguish an arc discharge generated in a switching operation for devices involving current switching such as a gas circuit breaker, a gas disconnector and so on.

The SF₆ gas is a very stable, harmless and nonflammable inert gas which has a very high electrical insulating capability and a discharge extinguishing capability (arc extinguishing capability) and has a great contribution to high performance and compactness of electric power transmission/distribution and transformation devices.

However, it is known that the SF₆ gas is contributing to high global warming, and there is an increasing need for reduction of use of SF₆ recently. A level of global warming is generally represented by a global warming factor, which is expressed by a relative value with respect to a carbon dioxide (CO₂) gas assumed as “1.” It is known that the global warming factor of SF₆ amounts to 23,900.

Under the above Background, it has been proposed to replace a SF₆ gas with a CO₂ gas as an insulating gas for electric power transmission/distribution and transformation devices (see, e.g., Non-Patent Document 1). Since a global warming potential of the CO₂ gas is so small to 1/23,900 of that of the SF₆ gas, there is possibility to control the effect on global warming by replacing the SF₆ gas with the CO₂ gas for electric power transmission/distribution and transformation devices.

In addition, although the CO₂ gas is inferior to the SF₆ gas in terms of insulation capability and arc extinguishment capability, it is known that the CO₂ gas has a superior arc extinguishment capability and the same or higher insulation capability as air mainly used as an insulating and arc extinguishing medium before the SF6 gas is used for gas-insulated devices for electrical power. That is, when the CO₂ gas is replaced for the SF₆ gas, it is possible to provide an environment-friendly electric power transmission/distribution and transformation device with high performance and controlled effect on global warming.

However, a device involving a current switching, such as a gas circuit breaker or a gas disconnector, essentially generates an arc discharge in an airtight container depending on its operation. When the arc discharge is generated in the airtight container, a gas with which the airtight container is filled is plasmalized in the course of discharging to cause deoxidization and recombination of molecules of the gas.

Since a SF₆ gas used for conventional electric power transformation devices has a very stable molecular structure, even when molecules of the SF₆ gas are once deoxidized by discharging, it is known that the molecules are mostly recombined into the original SF₆ molecules under normal environments. On the other hand, CO₂ deoxidized by the arc discharge is hard to be recombined into the original CO₂ and is deoxidized into a carbon monoxide (CO) gas and an oxygen gas. Although the oxygen gas is consumed by an oxidation reaction with metal in airtight container such as copper or iron, there is a possibility that the toxic CO gas is left.

The left CO gas may be inbreathed by a user when the user opens a filling gas for internal inspection of a CO₂ gas-insulated device performing a current switching, such as a gas circuit breaker. Therefore, under the present circumstances, the CO gas has to be limited in its discharge place or direction or has to be collected, which causes a problem of poor work efficiency of gas exchange, inspection and maintenance, as compared to a SF₆ gas circuit breaker.

Although a synthetic zeolite has been used as an adsorptive agent to adsorb and separate a SF₆ decomposition gas floating in a filling gas after current switching, if a CO₂ gas is replaced for the SF₆ gas, there is a problem that the zeolite cannot remove CO sufficiently as the zeolite adsorbs the insulating CO₂ gas.

### SUMMARY

Accordingly, it is an object in one aspect of the present disclosure to provide an environment-friendly gas-insulated device for electrical power with a CO₂ gas used as an arc extinguishing gas, which is capable of removing a CO gas generated by deoxidization of the CO₂ gas and performing internal inspection and maintenance with safety.

According to one aspect of the present disclosure, there is provided a gas-insulated device for electrical power, comprising: a fixed contact unit and a movable contact unit which are disposed to face with each other in an airtight container filled with a carbon dioxide gas or a gas mixture including a carbon dioxide gas, serving as an arc extinguishing gas. The fixed contact unit includes a fixed arc contact, a fixed conduction contact disposed outside the fixed arc contact, and a conductive supporting member for electrically connecting between the fixed arc contact and the fixed conduction contact and supporting these contacts. The movable contact unit includes a movable arc contact disposed slidably relative to the fixed arc contact, a movable conduction contact disposed to be slid with the fixed arc contact via an insulating nozzle outside the movable arc contact, a hollow operating rod which is disposed to be combined with a rear edge of the movable arc contact and has an opening formed at its rear edge, a cylinder which is disposed to support the insulating nozzle and the movable conduction contact outside the operating rod and has one opened end in the opposite side to the fixed contact unit, and a piston which is slidably inserted in a gap formed between the cylinder and the operating rod from the opened end of the cylinder and is disposed to partition a thermal compression chamber along with the cylinder and the operating rod. A metallic oxide is disposed at a portion contacting with a heat stream generated by an arc discharge of the fixed contact unit and the movable contact unit.

### BRIEF DESCRIPTION OF THE DRAWINGS

FIG. 1 is a sectional view showing a general configuration of a gas circuit breaker according to an embodiment.

### DESCRIPTION OF EMBODIMENTS

FIG. 1 is a sectional structural view of a puffer type gas circuit breaker used to break accident current in a high voltage system, as one example of a gas-insulated device for electrical power, according to an embodiment. Various parts shown in FIG. 1 have a coaxial cylindrical shape and FIG. 1 shows a state under a current breaking operation.

A puffer type gas circuit breaker 1 shown in FIG. 1 has an airtight container 2 made of grounded metal, an insulator or the like. The airtight container 2 is filled with a CO₂ gas or a gas mixture 1a including a CO₂ gas as a main component, serving as an electric insulating medium and an arc extinguishing medium. An example of a gas mixed with the CO₂ gas may include an unreactive gas such as a nitrogen gas, an inert gas or the like.

Within the airtight container 2 is provided a fixed contact unit 3 which is fixed in an insulating manner via a support insulating material 7 and includes a fixed arc contact 3a, a fixed conduction contact 3b disposed outside the fixed arc contact 3a, and a conductive supporting member 3c for electrically connecting between the fixed arc contact 3a and the fixed conduction contact 3b and supporting these contacts 3a and 3b.

In addition, a movable contact unit 4 is provided to face the fixed contact unit 3. The movable contact unit 4 includes an insulating nozzle 4a, a movable arc contact 4b disposed slidably relative to the fixed arc contact 3a, a movable conduction contact 4c disposed to be slid with the fixed arc contact 3a via the insulating nozzle 4a outside the movable arc contact 4b, a hollow operating rod 4d which is disposed to be combined with a rear edge of the movable arc contact 4b and has an opening formed at its rear edge, a cylinder 4e which is disposed to support the insulating nozzle 4a and the movable conduction contact 4c outside the operating rod 4d and has one opened end in the opposite side to the fixed contact unit 3, and a piston 4f which is slidably inserted in a gap formed between the cylinder 4e and the operating rod 4d from the opened end of the cylinder 4e and is disposed to partition a thermal compression chamber along with the cylinder 4e and the operating rod 4d.

The insulating nozzle 4a is made of polytetrafluoroethylene or the like which is an insulating material having high arc resistance.

Current is drawn out via a conductor 10 and a bushing (not shown). The conductor 10 is supported in an insulating manner by a spacer 11 and a region of a gas space in the airtight container 2 is partitioned by the spacer 11. Movability of the movable contact unit 4 is achieved when the operating rod 4d is connected to a movable part in an actuator 8 via a support insulating material 7.

A metallic oxide is disposed at a portion contacting with a heat stream generated by arc discharge 6 of the fixed contact unit 3 and the movable contact unit 4 disposed in the airtight container 2. Specifically, as will be described later in an operating method of the puffer type gas circuit breaker 1, when the heat stream of the arc discharge 6 transferred by a gas stream 9 contacts with the contacting portion, the metallic oxide is disposed at a portion where a temperature of the contacting portion is not less than 200 degrees C. In the puffer type gas circuit breaker 1 shown in FIG. 1, in many cases, this portion corresponds to at least one of the fixed arc contact 3a, the conductive supporting member 3c, the insulating nozzle 4a and the piston 4f.

In particular, in the fixed arc contact 3a, a leading end 3d close (or contacting) to the arc discharge 6 is likely to reach a high temperature of not less than 200 degrees C. by contacting with the heat stream of the arc discharge 6. In addition, in the piston 4f, a groove portion 4g close to the arc discharge 6 is also likely to reach a high temperature of not less than 200 degrees C. by contacting with the heat stream of the arc discharge 6.

Examples of the metallic oxide disposition method may include a method of forming the contacting portion of the heat stream of the arc discharge 6 with a metallic oxide, a method of coating the contacting portion with a cover material of a metallic oxide, a method of coating the contacting portion with a metallic oxide film, etc.

In a case where the contacting portion of the heat stream of the arc discharge 6 is formed with the metallic oxide, this contact portion can be obtained by filling powders of the metallic oxide in a forming mold having a space conforming to the size and shape of the contact portion, for example, the fixed arc contact 3a and so on, and sintering the powders at a predetermined temperature. In addition, similarly, for the cover material covering the contacting portion, this cover material can be obtained by filling powders of the metallic oxide in a forming mold having a space conforming an external dimension of the contact portion, for example, the fixed arc contact 3a and so on, and sintering the powders at a predetermined temperature. This cover material is fitted to the contacting portion. In addition, in a case where the contacting portion is covered with a metallic oxide film, a film is adhered to the contacting portion, for example, the fixed arc contact 3a and so on, by means of sputtering or the like using a target of metallic oxide.

The metallic oxide is preferably at least one selected from a group consisting of manganese oxide (MnO₂), cobalt oxide (CoO, CoO₂), copper oxide (CuO), vanadium pentoxide (V₂O₅), nickel oxide (NiO), iron oxide (Fe₂O₃), rhodium oxide (Rh₂O₃), ruthenium oxide (RuO₂), tin oxide (SnO₂) and molybdenum oxide (MoO₂), although not particularly limited as long as the metallic oxide can act as an oxidizer. When these oxides react with a CO gas generated by deoxidation of a CO₂ gas, the CO gas can be changed to the CO₂ gas, as will be described later in the operating method of the puffer type gas circuit breaker 1.

The above-mentioned metallic oxides allow the generated CO gas to be almost entirely changed to the CO₂ gas, thereby greatly reducing the residual amount of CO gas since it is inferred that the number of oxygen atoms involving in a reaction with the CO gas existing within a depth of 1 nm is equal to or more than the number of molecules of the CO gas generated by the arc discharge 6. In addition, these metallic oxides are thermally stabilized since their melting point or decomposition temperature is not less than 500 degrees C. Accordingly, even when these metallic oxides are disposed at the contacting portion of the heat stream due to the arc discharge 6, these metallic oxides are not decomposed before the heat stream contacts with the contacting portion, thereby preventing change of the CO gas to the CO₂ gas from being hindered.

An operation of the gas circuit breaker 1 shown in FIG. 1 will be now described. The fixed arc contact 3b and the movable arc contact 4b are in a contact conduction state when the gas circuit breaker 1 is closed. In a breaking operation, the fixed arc contact 3b and the movable arc contact 4b are separated from each other by their relative movement and, at the same time, a breaking arc discharge 6 is generated between both contacts 3b and 4b.

Subsequently, the fixed piston 4f compresses the internal space of the puffer cylinder 4e to increase its pressure. Then, a CO₂ gas 1a existing in the puffer cylinder 4e is rendered into a high pressure gas stream, which is rectified by the nozzle 4a and then sprayed to the arc discharge 6 generated between the arc contacts 3b and 4b. This can result in extinguishment of the conductive arc discharge 6 generated between the arc contacts 3b and 4b and current breaking. The gas sprayed to the arc discharge 6 is rendered into the gas stream 9, which passes through the interior of the fixed contact unit 3 and is diffused into the airtight container 2.

When the arc discharge 6 is generated in a CO₂ gas, the amount of the CO₂ gas which has to exist as an insulating gas originally is decreased while a CO gas, the decomposition gas of CO₂ gas, is increased. However, in this embodiment, a metallic oxide is disposed at a portion contacting with the heat stream generated by the arc discharge 6 of the fixed contact unit 3 and the movable contact unit 4 disposed in the airtight container 2, specifically at least one of the fixed arc contact 3a, the conductive supporting member 3c, the insulating muzzle 4a and the piston 4f. When the heat stream of the arc discharge 6 transferred by the gas stream 9 contacts with the contacting portion, since the temperature of the contacting portion reaches not less than 200 degrees C., the metallic oxide acts as an oxidizer to change the CO gas to the CO₂ gas based on, for example, the following reaction formula.

MnO₂+2CO→Mn+2CO₂

Accordingly, in a case where a CO₂ gas is used as an arc extinguishing gas, even when the CO₂ gas is deoxidized to generate a CO gas, the CO gas is instantly oxidized by the metallic oxide to be changed to a CO₂ gas. As a result, no CO gas remains in the airtight container 2, thereby preventing a human being from being injured when a filling gas is released for internal inspection.

That is, this embodiment can provide an environment-friendly gas-insulated device for electrical power with a CO₂ gas used as an arc extinguishing gas, which is capable of removing a CO gas generated by deoxidization of the CO₂ gas and performing internal inspection and maintenance with safety.

In addition, an oxygen (O₂) gas generated by the deoxidization of the CO₂ gas oxidizes metals, particularly copper and iron, in the airtight container 2 into oxides such as CuO and FeO.

Although, in this embodiment, the gas-insulated device for electrical power has been illustrated with the puffer type gas circuit breaker, this embodiment can be applied to various devices such as a gas-insulated switchgear, a gas disconnector, a gas-insulated transformer, a gas-insulated power line and so on using a CO₂ gas as an insulating gas.

While certain embodiments of the present invention have been described above, these embodiments are presented by way of example and are not intended to limit the scope of the present invention. These novel embodiments can be modified in many different forms. Various kinds of omission, substitution and modification may be made without departing from the scope and spirit of the present invention. These embodiments and the modifications thereof fall within the scope and spirit of the present disclosure and are included in the scope of the present disclosure recited in the claims and the equivalent thereof.

What is claimed is:

1. A gas-insulated device for electrical power, comprising:
a fixed contact unit and a movable contact unit which are disposed to face with each other in a container containing substantially carbon dioxide gas,
wherein a metallic oxide is disposed at a portion contacting with a heat stream generated by an arc discharge of the fixed contact unit and the movable contact unit.

2. The gas-insulated device for electrical power of claim 1, wherein the metallic oxide reduces an amount of carbon monoxide generated by the arc discharge.

3. The gas-insulated device for electrical power of claim 1 or 2, wherein the metallic oxide is at least one oxide selected from a group consisting of manganese oxide, cobalt oxide, copper oxide, vanadium pentoxide, nickel oxide, iron oxide, rhodium oxide, ruthenium oxide, tin oxide and molybdenum oxide.

4. The gas-insulated device for electrical power of claim 1 or 2 wherein at least a portion of the fixed contact unit or the movable contact unit comprise a metallic oxide.

5. The gas-insulated device for electrical power of claim 1 or 2 further comprising a conductive supporting member at least of portion of which comprises metallic oxide.

6. The gas-insulated device for electrical power of claim 1 or 2 wherein the metallic oxide contacting with a heat stream generated by an arc discharge of the fixed contact unit and the movable contact unit comprises enough contact with the heat stream for the metallic oxide to be used to convert at least of portion of any CO gas generated by the arc discharge to CO₂ gas.

4. A method of operating a gas-insulated device for electrical power, the device including:
a fixed contact unit and a movable contact unit which are disposed to face with each other in an airtight container filled with a carbon dioxide gas or a gas mixture including a CO₂ gas, serving as an arc extinguishing gas,
wherein the fixed contact unit includes a fixed arc contact, a fixed conduction contact disposed outside the fixed arc contact, and a conductive supporting member for electrically connecting between the fixed arc contact and the fixed conduction contact and supporting these contacts,
wherein the movable contact unit includes a movable arc contact disposed slidably relative to the fixed arc contact, a movable conduction contact disposed to be slid with the fixed arc contact via an insulating nozzle outside the movable arc contact, a hollow operating rod which is disposed to be combined with a rear edge of the movable arc contact and has an opening formed at its rear edge, a cylinder which is disposed to support the insulating nozzle and the movable conduction contact outside the operating rod and has one opened end in the opposite side to the fixed contact unit, and a piston which is slidably inserted in a gap formed between the cylinder and the operating rod from the opened end of the cylinder and is disposed to partition a thermal compression chamber along with the cylinder and the operating rod, and
wherein a metallic oxide is disposed at a portion contacting with a heat stream generated by an arc discharge of the fixed contact unit and the movable contact unit,
the method comprising: changing a carbon monoxide gas generated by deoxidization of the arc extinguishing gas to a carbon dioxide gas by a reaction of the carbon monoxide with the metallic oxide.

5. The method of claim 4, wherein the contacting portion is at least one of the fixed arc contact, the conductive supporting member, the insulating nozzle and the piston.

6. The method of claim 4 or 5, wherein the metallic oxide is at least one oxide selected from a group consisting of manganese oxide, cobalt oxide, copper oxide, vanadium pentoxide, nickel oxide, iron oxide, rhodium oxide, ruthenium oxide, tin oxide and molybdenum oxide.
